(19) United States
(12) Patent Application Publication
(10) Pub. No.: US 2020/0320541 A1
(43) Pub. Date: Oct. 8, 2020

(54) TECHNICAL SUPPORT TROUBLESHOOTING SYSTEMS

(71) Applicant: Andrew La, Tualatin, OR (US)

(72) Inventor: Andrew La, Tualatin, OR (US)

(21) Appl. No.: 16/376,035

(22) Filed: Apr. 5, 2019

(51) Int. Cl. G06Q 30/00; G06F 3/14; H04N 5/232; G06F 3/0484

(52) U.S. Cl. CPC G06Q 30/016; G06F 3/04845; H04N 5/23229; G06F 3/1423

(57) ABSTRACT

A method, system, apparatus, and/or device for troubleshooting or fixing a malfunctioning device. The method, system, apparatus, and/or device may include: executing a troubleshooting application to assist a first individual with troubleshooting or fixing a malfunctioning device; capturing an image or a video of the malfunctioning device; displaying the image or the video; sending the image or the video of the malfunctioning device to a second processing device; executing a support representative application to assist a second individual with assisting the first individual with troubleshooting or fixing the malfunctioning device; receiving the image or the video from the first processing device; displaying a graphical user interface (GUI); receiving troubleshooting information; sending the troubleshooting information to the first device; receiving the troubleshooting information from the second processing device; and displaying the troubleshooting information.

### BACKGROUND

Credit cards and debit cards are widely used for purchasing products and services. A credit card or debit card provides a user with many convenient ways to carry around money while obviating the need for cash to perform financial transactions, To perform the financial transactions, the credit card or the debit card may be swiped through or inserted into a card reader connected to a point-of-purchase terminal.

The card reader reads the customer's account information embedded in a magnetic strip or chip on the credit card and transmits the data of purchase transaction electronically to the card issuer's communication network for purchase authorization. The approval or rejection of the credit card or debit card purchase is electronically transmitted back to the point-of-purchase terminal. However, when a card reader fails or encounters an error, the card owner may not be able to complete a purchase and a merchant may lose money from a sale. When the failure or error occurs, a merchant may attempt to fix the error by troubleshooting the card reader.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a troubleshooting holder to hold a smart device approximate to a malfunctioning device, according to an embodiment.

FIG. 2 illustrates the troubleshooting holder in FIG. 1 with a malfunctioning device located on top of a base, according to an embodiment.

FIG. 3 illustrates the troubleshooting holder in FIG. 1 with the malfunctioning device located on top of the base and a smart device located on top of the platform, according to an embodiment.

FIG. 4A illustrates a flowchart for a method for initiating a troubleshooting application to provide troubleshooting support to a merchant, according to an embodiment.

FIG. 4B illustrates a GUI of the troubleshooting application to enter merchant profile information, according to an embodiment.

FIG. 4C illustrates a GUI of the troubleshooting application to view the merchant profile information of FIG. 4B, according to an embodiment.

FIG. 4D illustrates a GUI to initiate the troubleshooting application, according to an embodiment.

FIG. 4E illustrates a GUI to execute an assistance instruction of the troubleshooting application, according to an embodiment.

FIG. 4F illustrates a GUI to display the image or the video captured by the rear camera, sending the image or the video to the support representative device, and displaying troubleshooting information from the support representative device, according to an embodiment.

FIG. 4G illustrates a GUI to display a navigation menu to navigate to a merchant profile screen, according to an embodiment.

FIG. 4H illustrates a GUI to display a support ticket information screen, according to an embodiment.

FIG. 5A illustrates a flowchart for a method for initiating a support representative application to provide troubleshooting support to a merchant, according to an embodiment.

FIG. 5B illustrates a GUI of the support representative application to enter support representative profile information, according to an embodiment.

FIG. 5C illustrates a GUI of an initiated support representative application for a support representative awaiting an assistance request, according to an embodiment.

FIG. 5D illustrates a GUI of a support representative application displaying a malfunctioning device, according to an embodiment.

FIG. 5E illustrates a GUI of a support representative application displaying notification or message, according to an embodiment.

FIG. 5F illustrates a GUI of a support representative application displaying support tickets, according to an embodiment.

### DETAILED DESCRIPTION

The disclosed technical support troubleshooting systems will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, examples of various technical support troubleshooting systems are provided. Related features in the examples may be identical, similar, or dissimilar in different examples. For the sake of brevity, related features will not be redundantly explained in multiple examples. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Credit cards and debit cards are widely used for purchasing products and paying for services. A credit card or debit card owner (referred to hereafter as a card owner) may carry around a card to obviating the need around cash. To enable the card owner to perform a financial transaction with their card, a merchant may provide the card owner with a card reader to perform the financial transaction with their card. The card reader may read the customer's account information embedded in a magnetic strip or chip on the credit card and read financial data from the card to complete the financial transaction with a financial institution associated with the card owner.

When the card reader encounters an error or malfunctions, the merchant may attempt to reset the card reader or troubleshoot the error or malfunction. However, when the merchant is unable to resolve the error or malfunction, the merchant may contact a support representative to help them troubleshoot the error or malfunction. Conventionally, card readers do not support remote logging by the support representative because they do not include the hardware and/or operating system for a support representative to remotely access to the card readers. Other devices present the same or similar problem when a support representative is attempting to troubleshoot the device. For example, many printers, fax machines, and televisions also do not include the hardware and/or operating system for a support representative to remotely access the device. Additionally, other devices, such as smart enabled vehicles, may include the hardware and/or operating system needed for a support representative to remotely access the device but for security reasons, the device may not allow for remote access. For example, a Tesla® vehicle may include the hardware and/or operating system needed for remote access but may restrict a virtual private network (VPN) or remote access program from logging into the Tesla® vehicle because the vehicle manufacturer may not allow such access for security reasons.

Conventionally, when a support representative may not remotely access the device, the support representative will attempt to troubleshoot the device with the user over the telephone or perform an in-person visit to troubleshoot the device on site. However, in-person on-site visits are a costly and time-intensive process causing companies to often have their support representatives use a telephone to offer troubleshooting support. When a support representative provides troubleshooting support over the telephone, the support representative must rely on the merchant to describe the issue over the phone. However, while the merchant may describe the issue correctly, because the support representative cannot see the issue the support representative may misinterpret the issue. Additionally, when the support representative walks the merchant through the steps to resolve the issue, the merchant may inadvertently push the wrong button and cause the support representative to have to restart the troubleshooting process from the beginning to correctly troubleshoot the issue.

Implementations of the disclosure address the above-mentioned deficiencies and other deficiencies by providing methods, systems, devices, and apparatuses that provide a support representative with a system to view the device to troubleshoot and provide the merchant with visual feedback and/or aid in troubleshooting the device. An advantage of the technical support troubleshooting system may be to provide the merchant with virtual in-person troubleshooting assistance by enabling the support representative to view the device and the merchant's interaction with the device during the troubleshooting session. Additionally, the technical support troubleshooting system may provide the merchant with an efficient and cost-effective way to receive technical support without having to pay for an in-person troubleshooting visit.

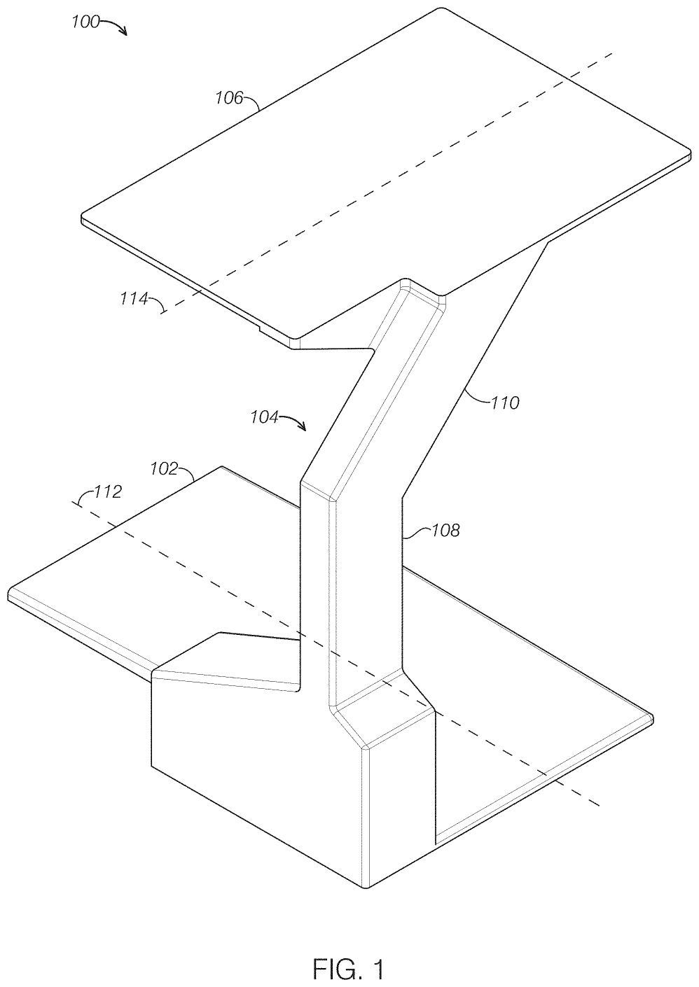

FIG. 1 illustrates a troubleshooting holder 100 to hold a smart device approximate to a malfunctioning device, according to an embodiment. In one embodiment, the troubleshooting holder 100 may include a base 102, an arm 104, and a platform 106. In one embodiment, the base 102 may be connected to a bottom end of the arm 104. The arm 104 may extend upward from the base 102 and a top end of the arm 104 may connect with a bottom surface of the platform 106.

In another embodiment, the base 102 may be a foundational structure configured to support the arm 104 and the platform 106. The base 102 may have a minimum amount of weight and/or cover a minimum area in order to reduce or eliminate the arm 104 and the platform 106 from tipping over or becoming unstable when a smart device is placed on a top surface of the platform 106. In one example, the base 102 may be a planar structure that extends along a latitudinal first axis 112.

A first end of the arm 104 may extend perpendicularly from the base 102 or at an angle upwardly from the base 102. In one example, the arm 104 may be attached to an edge or a side of the base 102. In one embodiment, the arm 104 may be a straight and uniform structure that extends from the base 102 to the platform 106. In another embodiment, the arm 104 may include a first portion 108 that extends perpendicularly upward from the base 102 and a second portion 110 that extends from a top of the first portion 108 at an angle and connects to the platform 106.

The platform 106 may be a planar structure that extends along a longitudinal second axis 114. In another embodiment, the base 102 may extend along the latitudinal first axis 112 and the platform may extend along the longitudinal second axis 114 so that the base 102 is offset from the platform 106. As discussed below, a malfunctioning device may be placed approximate to or at least partially on the top surface of the base 102 and a smart device may be placed on a top surface of the platform 106. In one example, the smart device may include a downward facing camera and an upward facing display. The offset between the base 102 and the platform 106 may enable a merchant to position the downward facing camera over the malfunctioning device so that the downward facing camera may capture an image or a video stream of the malfunctioning device as the merchant troubleshoots the malfunctioning device with the support representative. A merchant may be a representative of a company using the malfunctioning device, an owner of the malfunctioning device, a user of the malfunctioning device, an information technology (IT) representative, or another individual troubleshooting or fixing the malfunctioning device.

In one embodiment, the platform 106 may include a magnet attached to or integrated into the top surface of the platform 106. The magnet may aid the merchant in aligning the smart device on the platform 106 such that the smart device may correctly align the downward facing camera with a malfunctioning device. In another embodiment, the base 102, the arm 104, and/or the platform 106 may be one or more of a metal material, a plastic material, a polyurethane material, a glass material, and so forth.

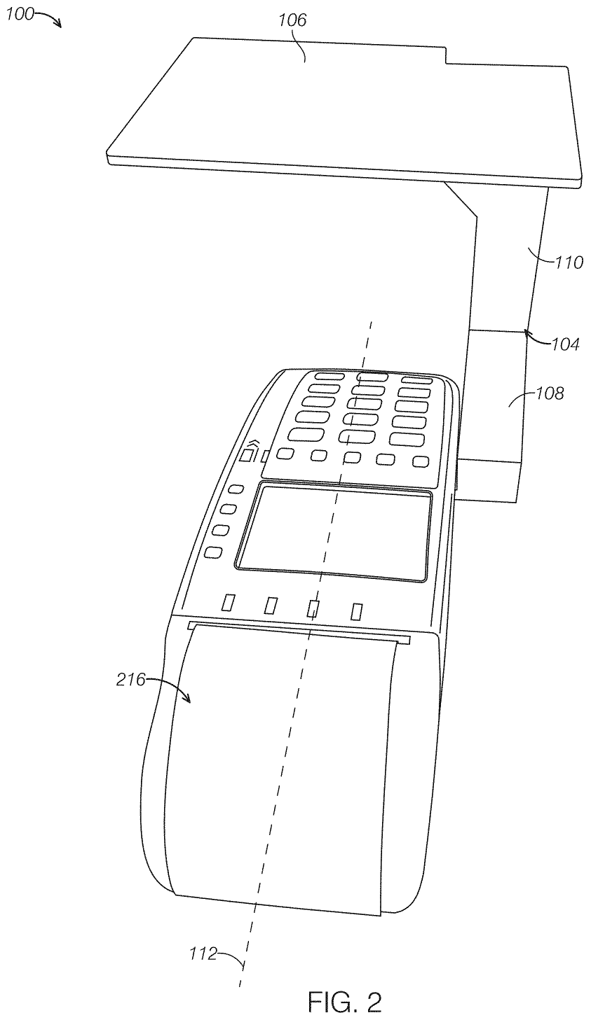

FIG. 2 illustrates the troubleshooting holder 100 in FIG. 1 with a malfunctioning device 216 located on top of the base 102, according to an embodiment. Some of the features in FIG. 2 are the same or similar to some of the features in FIG. 1 as noted by same reference numbers, unless expressly described otherwise. As discussed above, the troubleshooting holder 100 may be used to align the malfunctioning device 216 with a smart device by placing the malfunctioning device 216 on the base of the troubleshooting holder 100. In one embodiment, the malfunctioning device 216 may be a credit card processing device that a customer may use to perform a financial transaction when purchasing a good or service from the merchant. In another embodiment, the malfunctioning device 216 may extend or be positioned along the latitudinal first axis 112. In another embodiment, the malfunctioning device 216 may be a printer, a fax machine, a television, and so forth.

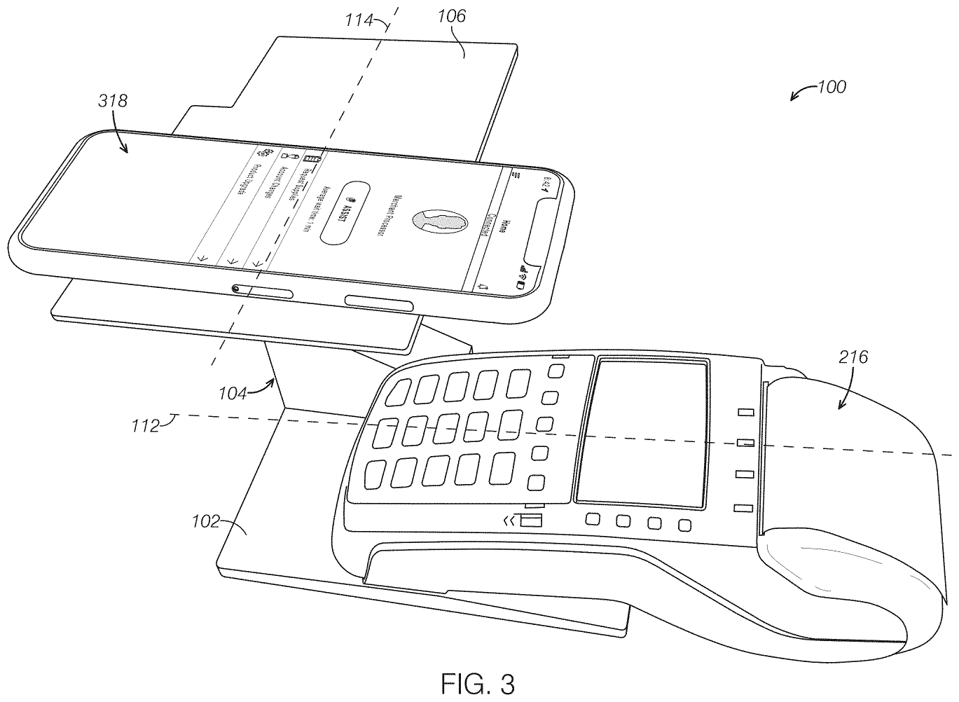

FIG. 3 illustrates the troubleshooting holder 100 in FIG. 1 with the malfunctioning device 216 located on top of the base 102 and a smart device 318 located on top of the platform 106, according to an embodiment. Some of the features in FIG. 3 are the same or similar to some of the features in FIGS. 1 and 2 as noted by same reference numbers, unless expressly described otherwise. As discussed above, the troubleshooting holder 100 may be used to align the malfunctioning device 216 with the smart device 318 by placing the malfunctioning device 216 on the base of the troubleshooting holder 100 and the smart device 318 on top of the platform 106. In one embodiment, the malfunctioning device 216 and the smart device 318 may extend or be positioned along the latitudinal first axis 112 such that the malfunctioning device 216 and the smart device 318 extend in the same direction. The smart device 318 may be a device with a processing device, a camera, and a display.

When the malfunctioning device 216 has been placed on the base 102 and the smart device 318 has been placed on the platform 106, the merchant may initiate a troubleshooting application on the smart device 318. In one example, the troubleshooting application may establish a communication link between the smart device 318 and the support representative device such that the merchant may communicate with the support representative and receive aid in troubleshooting and/or fixing the malfunctioning device 216. As discussed below, the troubleshooting application communicates with a support representative application executing on a device associated with the support representative (also referred to as a support representative device).

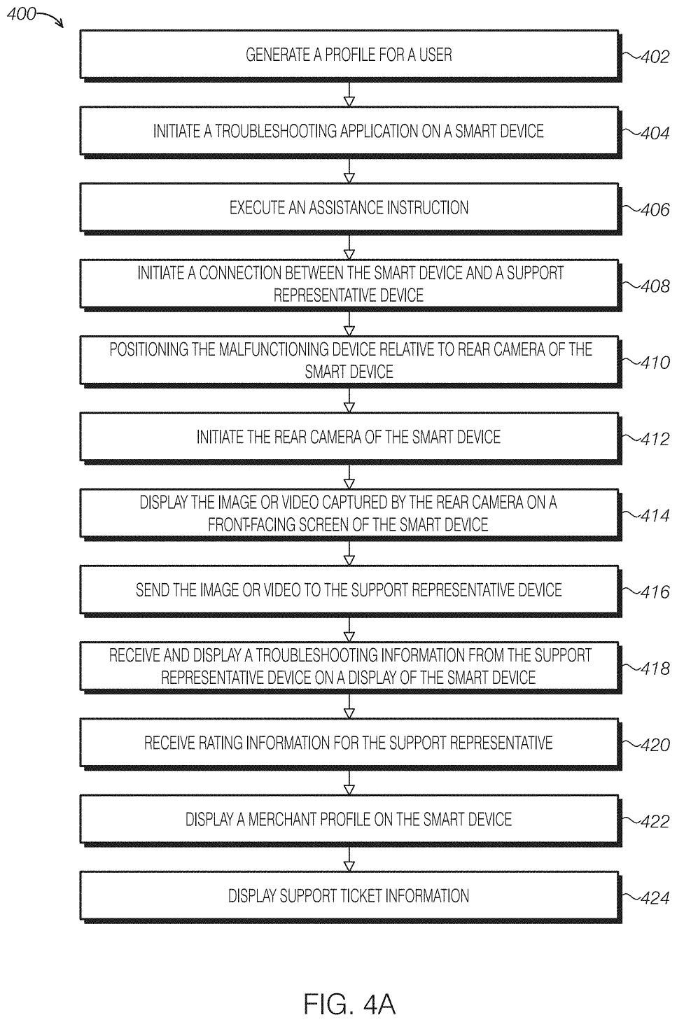

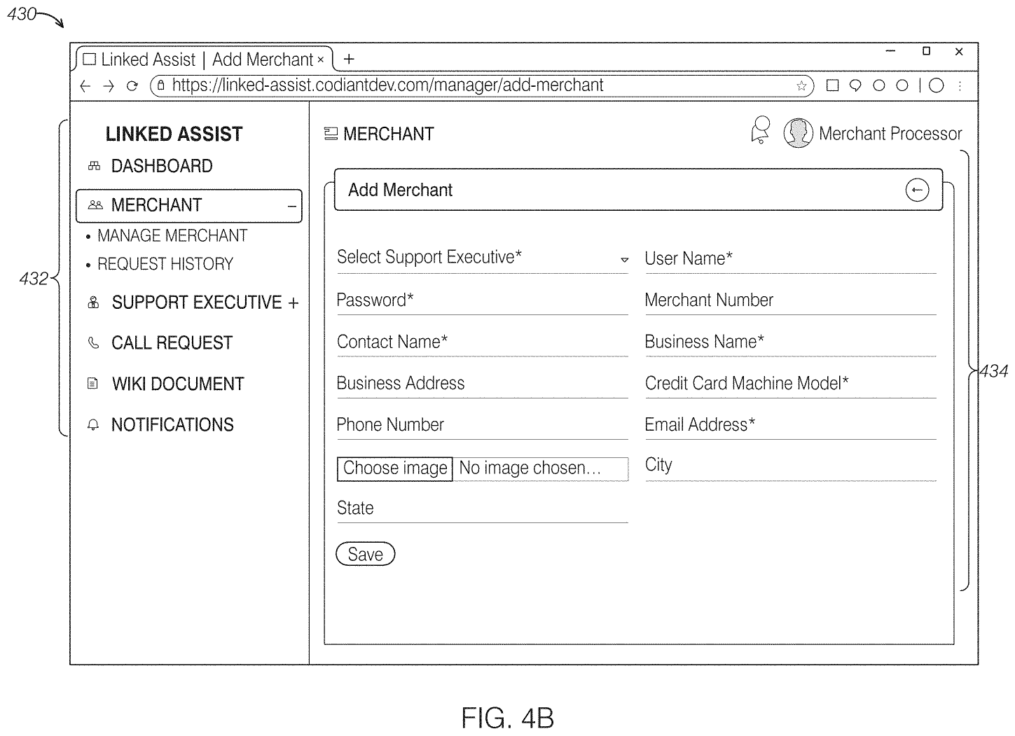

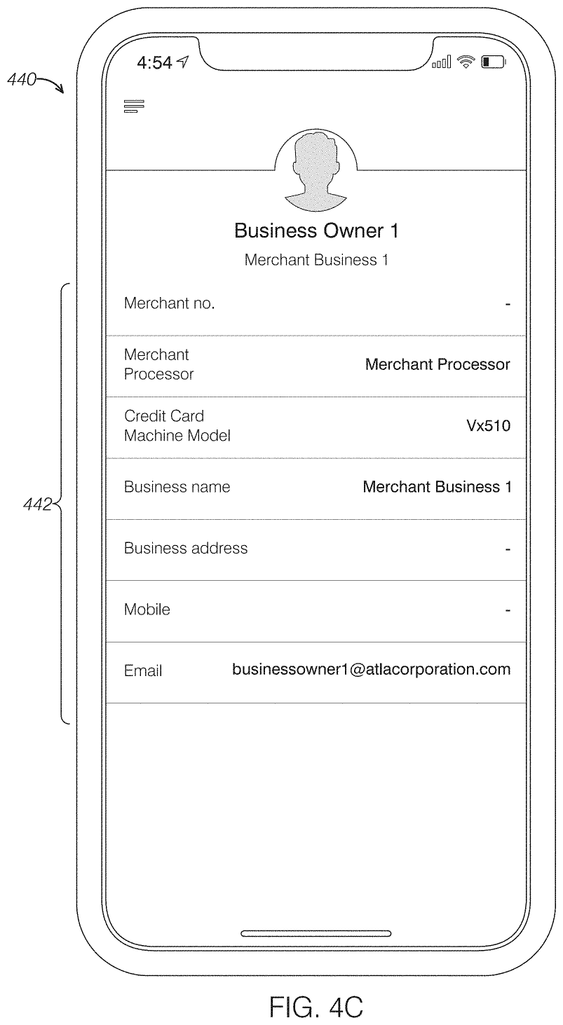

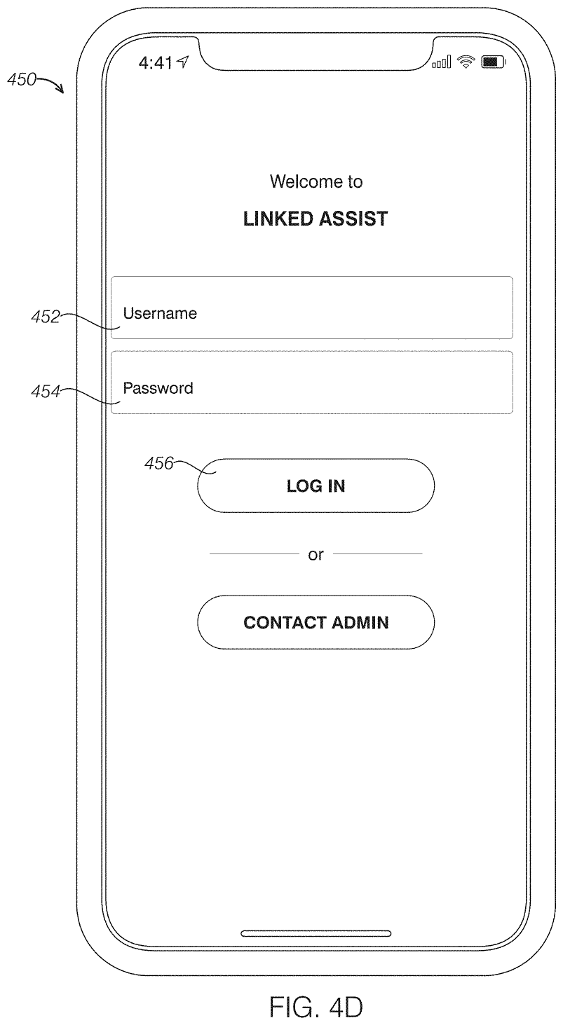

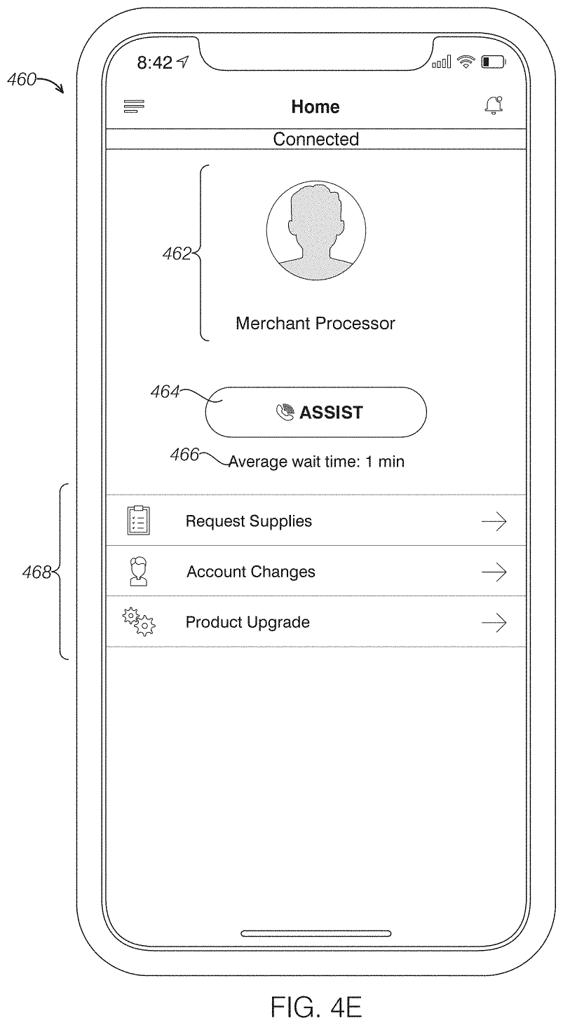

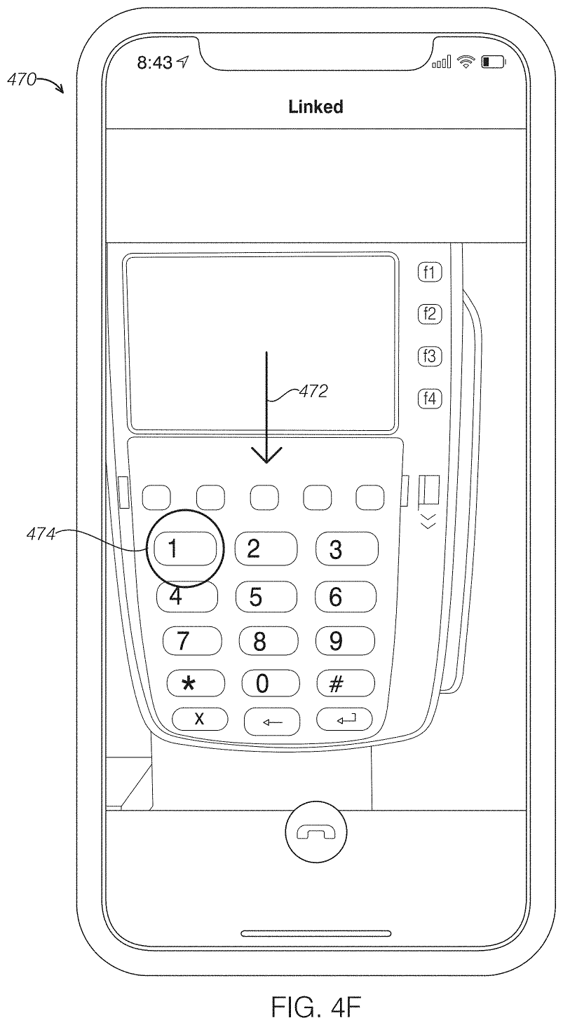

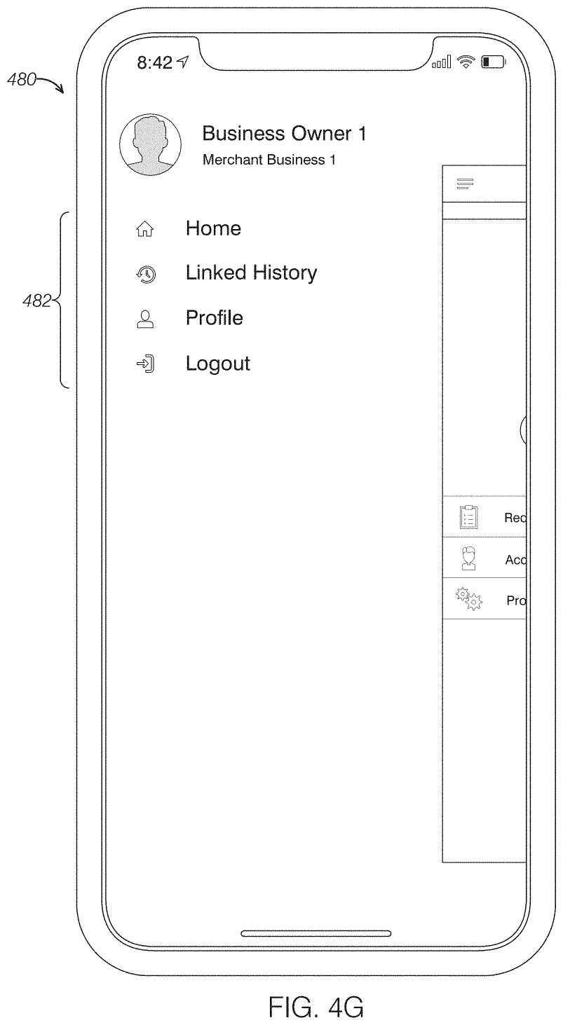

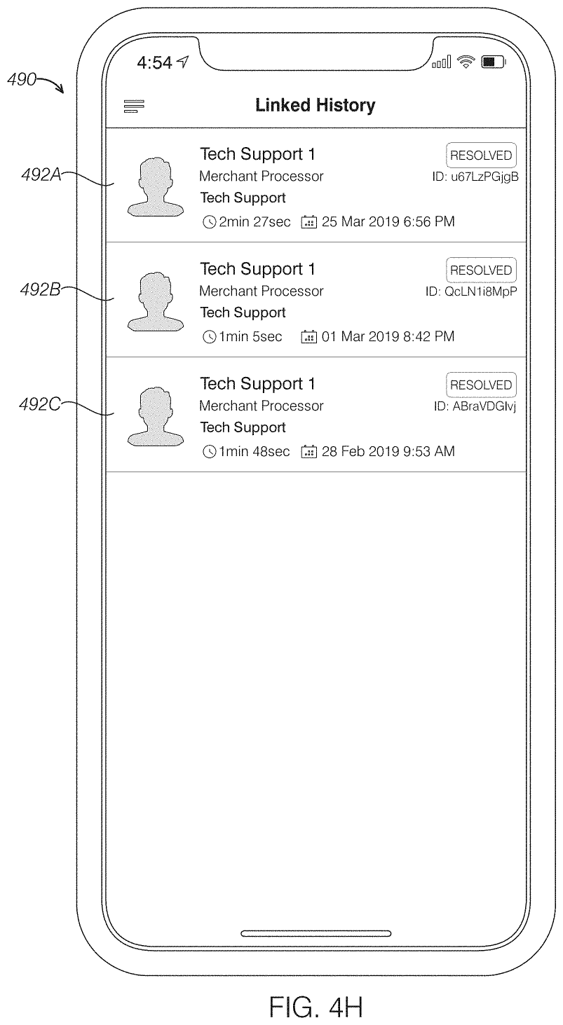

FIG. 4A illustrates a flowchart 400 for a method for initiating a troubleshooting application to provide troubleshooting support to a merchant, according to an embodiment. In one embodiment, the method in flowchart 400 may be performed by a troubleshooting application executing on a processing device of the smart device 318 in FIG. 3. The method may include generating a profile for the user (block 402). In one embodiment, a smart device associated with a user may receive user input via an input device coupled to the smart device. In one example, the input device may be a touch screen display, a touch input device, a keyboard, a mouse, a trackpad, a camera, and so forth. The user input may include information for the merchant profile, such as a username, a password, a merchant identification number (MID), a contact name, a business name, a business address, a credit card machine model, a phone number, an email address, and so forth.

The method may include initiating a troubleshooting application on a smart device (block 404). In one example, a smart device may initiate the troubleshooting application by receiving an input from the merchant via the input device. In one example, the input may include the merchant selecting the troubleshooting application on the smart device. In another example, the input may include login information associated with the merchant, such as a username and/or a password. In one embodiment, the username and/or password may be generated by the merchant. In another embodiment, the username and/or password may be generated by a provider of the malfunctioning device.

The method may include executing an assistance instruction (block 406). In one embodiment, when the troubleshooting application is initiated, the application may display a graphical user interface (GUI) with a graphical object or text object for the merchant to interact with, such as via an input device. For example, the GUI may include an assistance button for the merchant to select to execute the assistance instruction. The assistance instruction may send an assistance request to a backend server or another device associated with a support representative. As discussed below, when the backend server or the other device receives the assistance request, the backend server or the other device may execute an assistance application for the support representative to provide assistance to the merchant.

The method may include initiating a connection between the smart device and a device associated with the support representative (block 408). In one embodiment, when the smart device sends the assistance request to the backend server or the other device, the backend server and/or the other device may identify a support representative device associated with a support representative that is available to provide troubleshooting aid to the merchant during a troubleshooting session

In one embodiment, when the merchant taps or selects a graphical object displayed in the GUI via an input device, the smart device may send the assistance request to the backend server or the other device to identify a support representative device associated with a support representative that is available to provide troubleshooting aid to the merchant. The graphical object may be a graphical button, a text object, and so forth. In another embodiment, when the merchant selects the graphical object displayed in the GUI via the input device, the assistance request may be placed into a queue for the backend server or the other device to identify a support representative to aid the merchant based on the ranking of the assistance request in the queue. In one embodiment, the ranking of the assistance request may be based on the time the assistance request was sent. In another embodiment, the ranking may be based on a priority level associated with the merchant profile of the merchant. In another embodiment, when the assistance request is sent, an urgency level may be associated with the assistance request based on the type of issue the merchant needs assistance with. When the assistance request has been placed in the queue, the troubleshooting application executing on the smart device may minimize for the period where the merchant is waiting for assistance and then the troubleshooting application may be maximized or display a notification when the support representative is prepared to provide assistance.

When the support representative is prepared to provide assistance, the smart device and/or the support representative device may initiate a connection between the smart device and the support representative device. In one embodiment, the connection may be a communication channel for the smart device and the support representative device to exchange data, audio, video, live streaming data, live streaming audio, live streaming video, and so forth. The merchant and/or the support representative may exchange information via the communication channel to aid the merchant in fixing or troubleshooting the malfunctioning device.

The method may include positioning the malfunctioning device relative to a rear camera of the smart device (block 410). In one embodiment, the troubleshooting software may display a notification to the merchant instructing the merchant to position the smart device approximate to the malfunctioning device such that a rear camera of the smart device may capture an image or a video of the malfunctioning device. For example, as discussed in FIG. 3, the malfunctioning device 216 may be positioned on top of the base 102 of the troubleshooting holder 100 and the smart device 318 may be positioned on top of the platform 106 of the troubleshooting holder 100 so that a rear camera of the smart device 318 may capture an image or a video of the malfunctioning device. In another example, the merchant may use a holder other than the troubleshooting holder 100 to position the rear camera of the smart device to capture the image or the video of the malfunctioning device. In another example, the merchant may hold the smart device with their hand to position the rear camera of the smart device to capture the image or the video of the malfunctioning device. In another example, the troubleshooting application may display an outline on a front-facing display of the smart device to guide the merchant on how to position the smart device relative to the malfunctioning device.

The method may include initiating the rear camera of the smart device (block 412). For example, once the rear camera of the smart device is positioned to capture the image or the video of the malfunctioning device, the troubleshooting application may initiate the rear camera to capture the image or the video of the malfunctioning device. In another example, when the connection between the smart device and the device associated with the support representative is established, the troubleshooting application may initiate the rear camera to capture the image or the video of the malfunctioning device.

When the rear camera has been initiated, the troubleshooting application may display the image or the video captured by the rear camera on a front-facing display of the smart device (block 414). The front-facing display may face the opposite direction of the rear camera such that the merchant may be able to view the front-facing display while the rear camera captures the image or the video. In one embodiment, the image or the video may be delayed or captured prior to the front-facing display displaying the image or the video. In another example, the image or the video may be captured and displayed live on the screen.

The troubleshooting application may send the image or the video captured by rear camera to the support representative device (block 416). In one embodiment, the troubleshooting application may send information associated with the malfunctioning device along with the image or the video. The information may include a model number or name of the malfunctioning device, an error code of the malfunctioning device, a description of how the malfunctioning device is malfunctioning, merchant profile information, and so forth.

In one example, the merchant may input the information via a GUI of the troubleshooting device. In another example, the troubleshooting application may use an image recognition function to determine the information. In one embodiment, the image recognition function may use visual cues in the image or the video to identify the model number or the model name of the malfunctioning device and query a database to retrieve information associated with the model number or the model name. In another embodiment, the image recognition function may use visual cues shown on a display of the malfunctioning device to determine the error code and/or a description of how the malfunctioning device is malfunctioning and query a database to retrieve information associated with the error code and/or description. The visual cue information may include a shape (size, dimensions, length, width, etc.) of the malfunctioning device, a color of the malfunctioning device, identifying marks of the malfunctioning device, name indicators of the malfunctioning device, text on or approximate the malfunctioning device, button information of the malfunctioning device (such as button shapes, button positions, button colors), and so forth.

The method may include receiving and displaying troubleshooting information from the support representative device on a display of the smart device (block 418). As discussed below, the support representative device may execute a support representative application to communicate with the troubleshooting application. The support representative may use an input device coupled to the support representative device to input troubleshooting information into the support representative application. The support representative application may send the troubleshooting information to the troubleshooting application and the troubleshooting application may display the troubleshooting information to the merchant via the front-facing display of the smart device. The troubleshooting information may include a text object, a graphical object, a video, a link or a hyperlink to a troubleshooting article or handbook, and so forth.

In one embodiment, the troubleshooting application may overlay the troubleshooting information onto the image or the video of the malfunctioning device. For example, the troubleshooting application may overlay a graphical object such as a circle or a sketch onto the image or the video of the malfunctioning device to indicate a button, a key, a switch, and so forth that the support representative desires the support representative to press or activate. In another example, the troubleshooting application may overlay a text object to instruct the merchant of a troubleshooting step(s) to take. In another example, the troubleshooting application may overlay a video or text object illustrating a troubleshooting step(s) to take. The connection between the troubleshooting application and the support representative application may allow the merchant and the support representative to communicate with each other. For example, as the troubleshooting application overlays the troubleshooting information, the merchant and the support representative may communicate via an audio connection to talk with each other and/or a video connection to see each other. The communications between the merchant and the support representative may be in a single direction (where the merchant or the support representative is the only one who may speak or be seen) or a dual direction (where the merchant and the support representative may both speak or be seen).

The method may include receiving rating information regarding the support representative (block 420). For example, when the merchant and the support representative have completed the troubleshooting steps to troubleshoot and/or fix the malfunctioning device, the troubleshooting application may display a rating interface for the merchant to rate the merchant's experience with the support representative. The troubleshooting steps to troubleshoot and/or fix the malfunctioning device may be completed when the merchant and/or the support representative disengage the connection, such as when the merchant and/or the support representative hang up or initiate an end command via a GUI of the troubleshooting application or the support representative application. The merchant may input the rating information via an input device coupled to the smart device.

The method may include displaying the merchant profile of the user and/or support ticket information on the smart device (block 422). For example, the troubleshooting software may include a menu for the merchant to navigate to view the merchant profile information. In one example, the merchant profile information may include information associated with a troubleshooting session for a support representative, such as a day, a time, a support or ticket number, and so forth of a troubleshooting session where the support representative provided assistance to the merchant via the troubleshooting application and the support representative application. In another example, the merchant profile information may include a history of support representative(s) provided assistance to the merchant via the troubleshooting application and the support representative application.

FIG. 4B illustrates a GUI 430 of the troubleshooting application to enter merchant profile information, according to an embodiment. The GUI 430 may be a website page, a page or sub-GUI of a computer or tablet device application, a page or sub-GUI of a smartphone application, a page or sub-GUI of a smart device application, and so forth. The GUI 430 may be part of the troubleshooting application discussed above.

As discussed above, block 402 of the method in flowchart 400 may include generating a profile for a user. The GUI 430 may include a menu field 432 for a merchant and/or an administrator to select a page of the GUI 430 to input merchant profile information. The GUI 430 may also include a merchant profile section 434 with fields to receive merchant profile information. In one embodiment, the fields in the merchant profile section 434 may include text fields, image upload fields, graphical objects, buttons, drop-down menus, and so forth. In another embodiment, the fields may include a field to select an account executive, a username field, a password fields, a merchant number field, a contact name fields, a business name fields, a business address field, a credit card machine model field, a phone number field, an email address field, an image upload field, a city field, a state field, and/or a save button.

FIG. 4C illustrates a GUI 440 of the troubleshooting application to view the merchant profile information of FIG. 4B, according to an embodiment. The GUI 440 may be a website page, a page or sub-GUI of a computer or tablet device application, a page or sub-GUI of a smartphone application, a page or sub-GUI of a smart device application, and so forth. The GUI 440 may be part of the troubleshooting application discussed above. As discussed above, block 402 of the method in flowchart 400 may include generating a profile for a user. The GUI 440 may include a merchant profile field 442 that may display a portion or all of the merchant profile information received at GUI 430 in FIG. 4B.

FIG. 4D illustrates a GUI 450 to initiate the troubleshooting application, according to an embodiment. The GUI 450 may be a website page, a page or sub-GUI of a computer or tablet device application, a page or sub-GUI of a smartphone application, a page or sub-GUI of a smart device application, and so forth. The GUI 450 may be part of the troubleshooting application discussed above. As discussed above, block 404 of the method in flowchart 400 may include initiating the troubleshooting application on a smart device.

The GUI. 450 may include merchant verification fields 452 and 454 and an initiation button 456. In one embodiment, the merchant verification field 452 may be a field to receive merchant identification information associated with an account for the merchant to use the troubleshooting application, such as a username or user ID associated with the merchant account. In another embodiment, the merchant verification field 454 may be a field to receive merchant security information associated with an account for the merchant to use the troubleshooting application, such as password associated with the merchant account. A merchant may enter information into the merchant verification fields 452 and 454 via an input device, such as a touch screen, a touch device, a keyboard, a mouse, a trackpad, and so forth. When the troubleshooting application receives the merchant verification information, the merchant may use the input device to select the initiation button 456. When the merchant selects the initiation button 456, the troubleshooting application may verify the merchant verification information and if the merchant verification information matches the merchant verification information associated with the merchant account, the troubleshooting application may be initiated or logged into.

FIG. 4E illustrates a GUI 460 to execute an assistance instruction of the troubleshooting application, according to an embodiment. The GUI 460 may be a website page, a page or sub-GUI of a computer or tablet device application, a page or sub-GUI of a smartphone application, a page or sub-GUI of a smart device application, and so forth. The GUI 460 may be part of the troubleshooting application discussed above. As discussed above, block 406 of the method in flowchart 400 may include executing an assistance instruction of the troubleshooting application.

The GUI 460 may include a merchant profile field 462, an assistance button 464, a wait time indicator 466, and/or an other activities menu 468. The merchant profiled field 462 may display at least some of the merchant profile information received in the GUI 430 in FIG. 4B to indicate to a merchant the account that is logged into. The assistance button 464 may be selected by the merchant via an input device to execute an assistance instruction of the troubleshooting application. The assistance instruction may establish a connection between a smart device and a support representative device as discussed above. The wait time indicator 466 may indicate an amount of time a merchant may have to wait for the connection to be made between the smart device and the support representative device.

FIG. 4F illustrates a GUI 470 to display the image or the video captured by the rear camera, sending the image or the video to the support representative device, and displaying troubleshooting information from the support representative device, according to an embodiment. The GUI 470 may be a website page, a page or sub-GUI of a computer or tablet device application, a page or sub-GUI of a smartphone application, a page or sub-GUI of a smart device application, and so forth. The GUI 470 may be part of the troubleshooting application discussed above. As discussed above, blocks 414-418 of the method in flowchart 400 may include displaying the image or the video captured by the rear camera on a front-facing display of the smart device, sending the image or the video to the support representative device, and displaying a troubleshooting information from the support representative device on a display of the smart device.

The GUI 470 may include an image or a video of the malfunctioning device. The image or the video of the malfunctioning device may include a first media object 472 and/or a second media object 474. The first media object 472 and/or the second media object 474 may be a text object, a graphical object, a video object, a data streaming object, and so forth. The first media object 472 and/or the second media object 474 may be generated by a support representative using a support representative application in communication with the troubleshooting application. The support representative may generate the first media object 472 and/or the second media object 474 via an input device to provide the merchant with assistance or directions in troubleshooting or fixing the malfunctioning device. For example, the first media object 472 may be an arrow directing a merchant to push a button or switch on the malfunctioning device. In another example, the second media object 474 may be a circle directing a merchant to push a button or switch on the malfunctioning device.

FIG. 4G illustrates a GUI 480 to display a navigation menu 482 to navigate to a merchant profile screen, according to an embodiment. The GUI 480 may be a website page, a page or sub-GUI of a computer or tablet device application, a page or sub-GUI of a smartphone application, a page or sub-GUI of a smart device application, and so forth. The GUI 480 may be part of the troubleshooting application discussed above. As discussed above, block 422 of the method in flowchart 400 may include displaying a merchant profile on the smart device.

The GUI 480 may include a navigation menu 482. The navigation menu 482 may include links or buttons for the merchant to navigate to a home screen, a history screen, a profile screen, or a logout screen. For example, the troubleshooting software may include a menu for the merchant to navigate to view the merchant profile information.

FIG. 4H illustrates a GUI 490 to display a support ticket information screen, according to an embodiment. The GUI 490 may be a website page, a page or sub-GUI of a computer or tablet device application, a page or sub-GUI of a smartphone application, a page or sub-GUI of a smart device application, and so forth. The GUI 490 may be part of the troubleshooting application discussed above. As discussed above, block 424 of the method in flowchart 400 may include displaying a support ticket information screen on the smart device. In one example, the GUI 490 may display one or more support tickets, such as support tickets 492A-492C. The support tickets 492A-492C may include support ticket information associated with one or more troubleshooting sessions, such as the support representative's name, the merchant's name, a ticket identification number, a time of day the support ticket was created, an amount of time the support representative provided aid to the merchant, whether the issue with the malfunctioning device was resolved or is still open, and so forth. The merchant profile information may include a history of support representative(s) provided assistance to the merchant via the troubleshooting application and the support representative application.

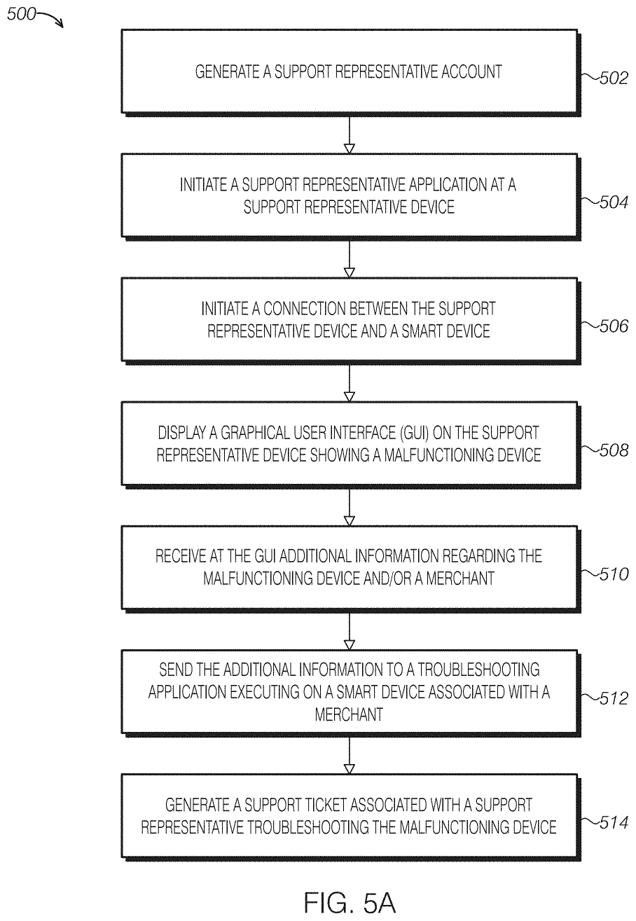

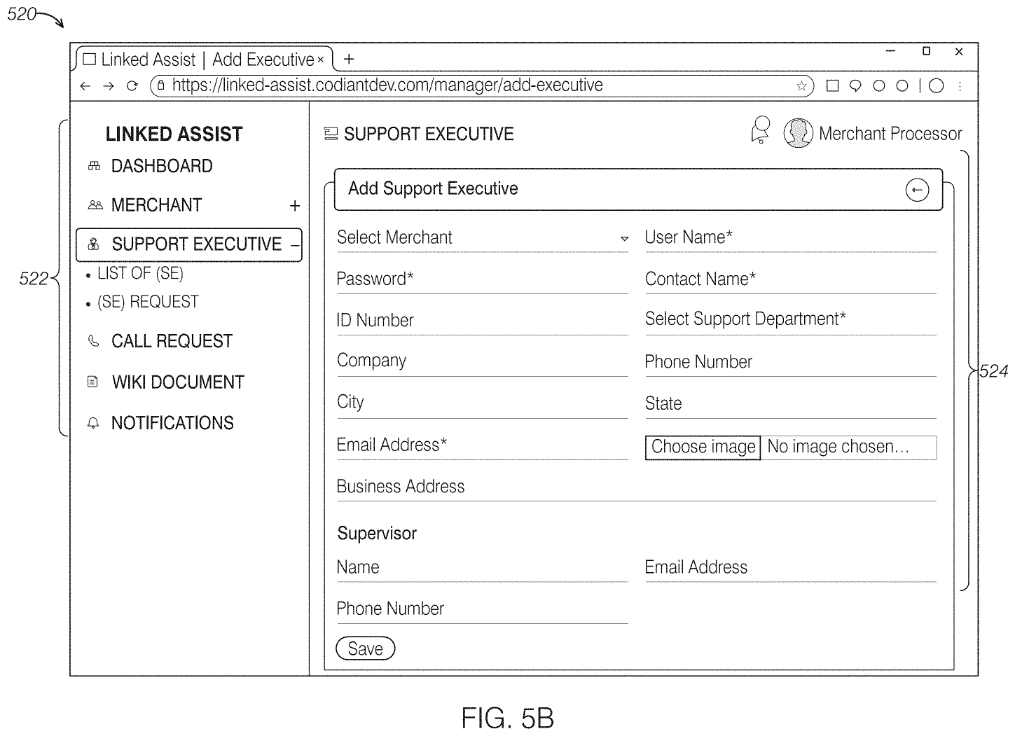

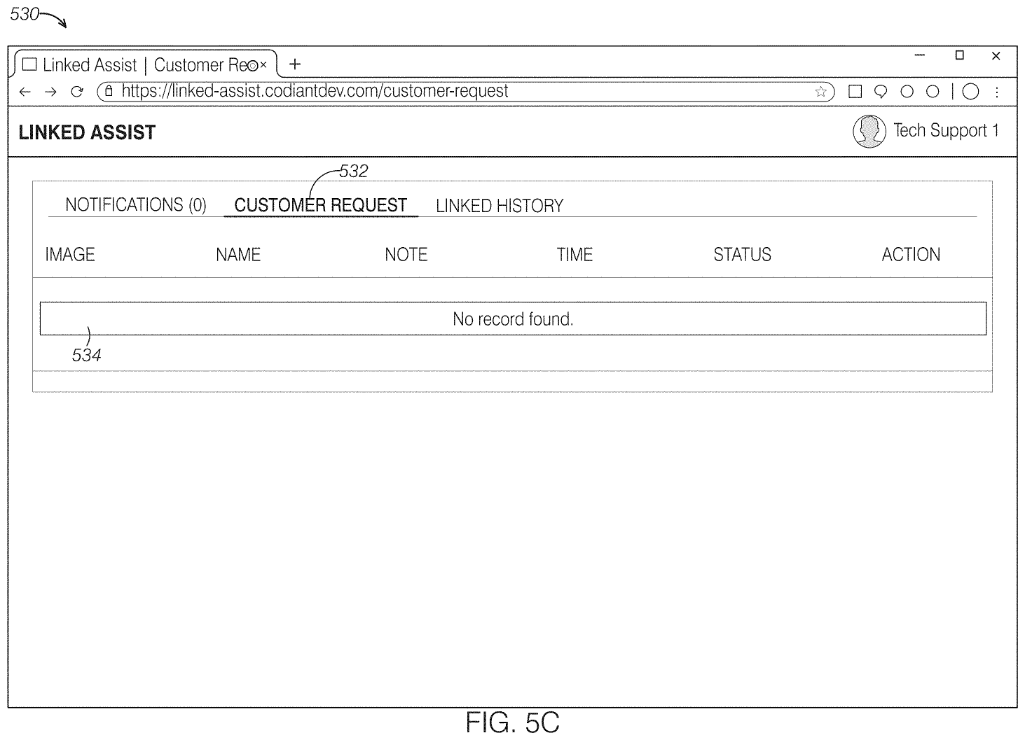

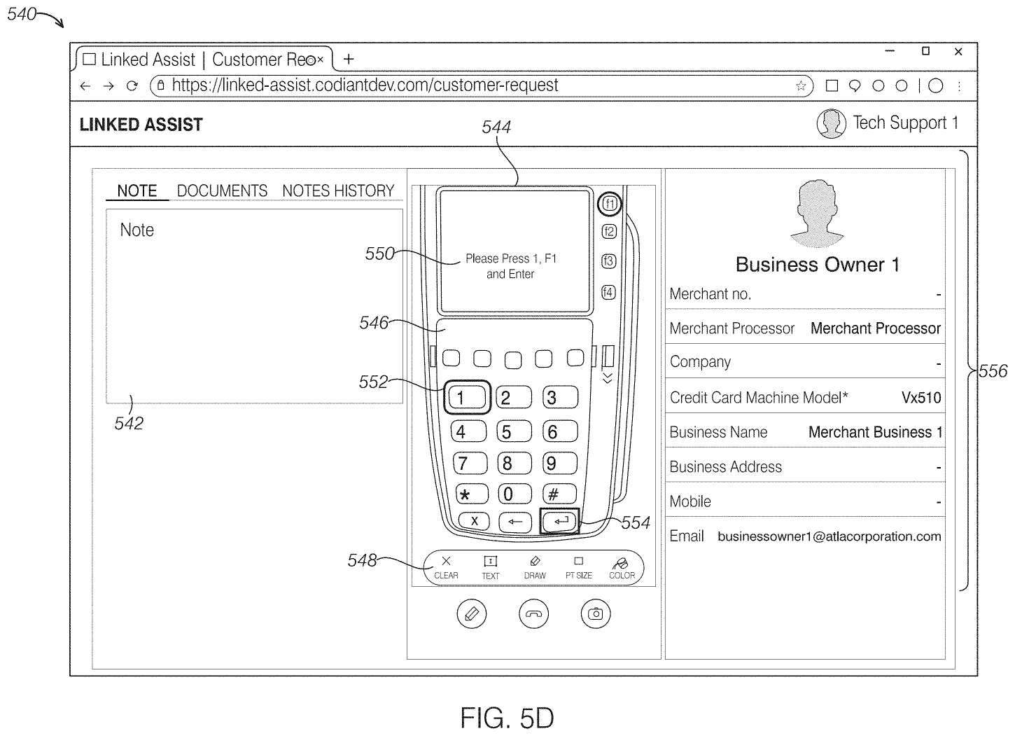

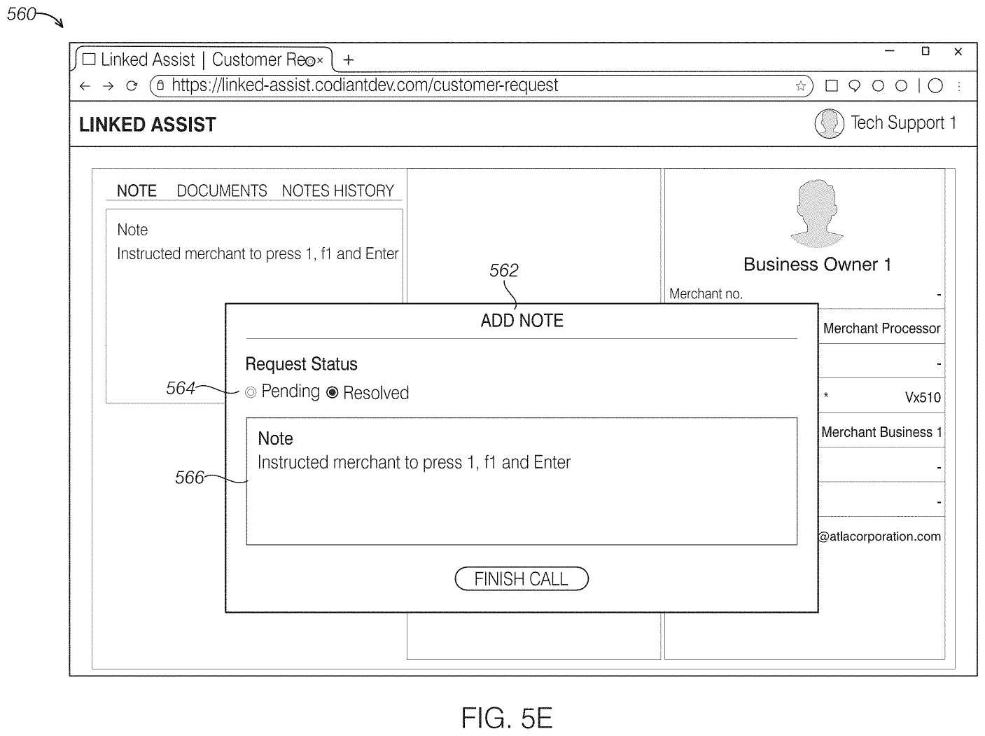

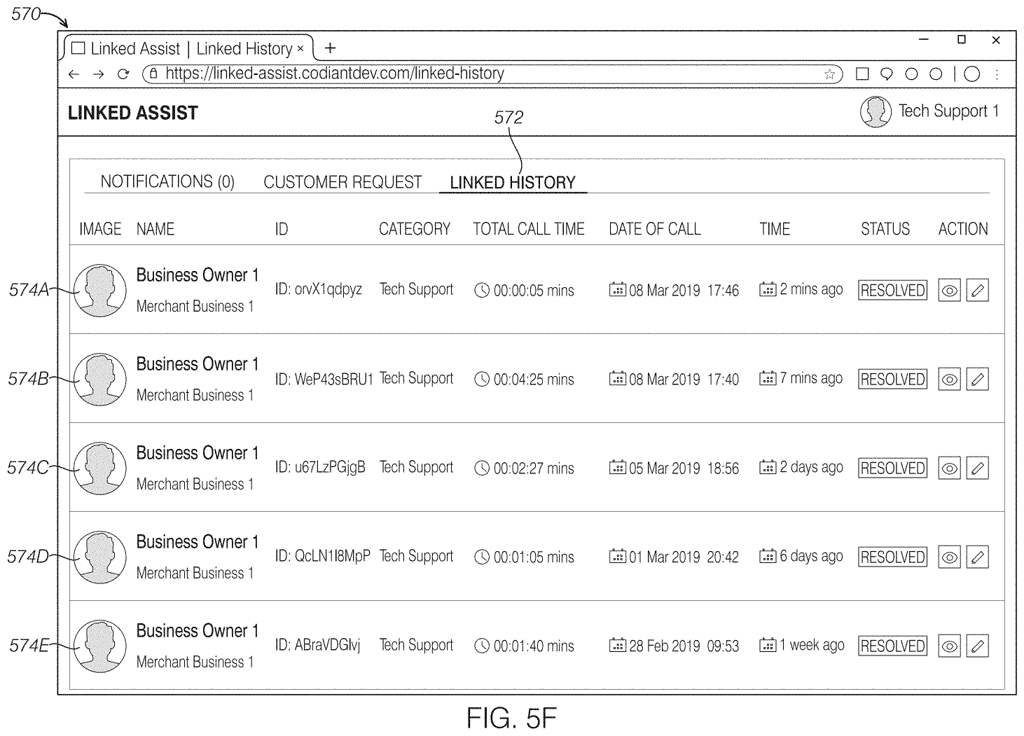

FIG. 5A illustrates a flowchart 500 for a method for initiating a support representative application to provide troubleshooting support to a merchant, according to an embodiment. In one embodiment, the method in flowchart 500 may be performed by a support representative application executing on a processing device of the device associated with the support representative, i.e. a support representative device.

The method may include generating a support representative account (block 502). In one embodiment, a device associated with a support representative or an administrator may receive input via an input device coupled to the device. In one example, the input device may be a touch screen display, a touch input device, a keyboard, a mouse, a trackpad, a camera, and so forth. In one example, the input may include information about the support representative profile, such as a username, a password, a support representative identification number (SRID)), a name, a phone number, an email address, address information, support department information, a business address and so forth, In another example, the input may include information about a supervisor of the support representative, such as a name of the supervisor, an email address of the supervisor, a phone number of the support representative, and so forth. In another example, an administrator (such as a merchant processor) or a support representative may log into the support representative application and create a login and profile for a support representative. Once the support representative profile has been generated, the administrator or the support representative may assign the support representative to receive assistance requests or support tickets for a merchant or a type of malfunctioning device.

The method may include initiating a support representative application at the support representative device (block 504). In one example, the support representative may log into the support representative application may wait for an assistance request or support ticket. The support representative may log into the support representative application via a software application, a web browser, a smart device app, and so forth.

The method may include initiating a connection between the support representative device and the smart device 318 in FIG. 3 (block 506). The support representative application may receive an assistance request and may display a GUI for the support representative to accept the assistance request and initiate a troubleshooting session. For example, the GUI may display the assistance request and a button for the support representative to accept the assistance request and a troubleshoot screen may be displayed on the support representative device.

The method may include displaying a graphical user interface (GUI) on the support representative device showing a malfunctioning device (block 508). Once the support representative accepts the assistance request, the GUI may display the assistance screen. The assistance screen may display merchant profile information associated with the merchant making the assistance request, a text box to record notes taken by the support representative, a tab or screen to view documents (such as troubleshooting guides and manuals), and previous support ticket information. The GUI may include a media object portion to display an image and/or video of the malfunctioning device as captured by a rear camera of a smart device associated with the merchant. Future updates will have the system recognize the device and any error codes visibly present.

The method may include receiving at the GUI additional information regarding the malfunctioning device and/or the merchant (block 510). In one example, the additional information may include text, a graphical object, a video object, a streaming data object, and so forth that may be a prompt or an aid to the merchant troubleshooting or fixing the malfunctioning device. In another example, during and/or after the troubleshooting session, the support representative may use the input device to input notes into the support representative software to record or store for future reference. The method may include sending the additional information to a troubleshooting application executing on a smart device associated with the merchant (block 512). For example, when the additional information is a prompt or aid, the additional information may be overlaid or integrated into an image or a video of the malfunctioning device and may be sent to the smart device.

The method may include generating a support ticket associated with the support representative troubleshooting the malfunctioning device (block 514). A support ticket may be a service request from a merchant that is received by a support representative application and recorded for future reference. The support ticket may include an audio and/or video record of the support representative, an audio and/or video record of the merchant, a screen recording of the support representative application, a screen recording of the troubleshooting application, and so forth, in one example, the GUI of the support representative software may record other information related to the troubleshooting session, such as a date and/or time the troubleshooting session occurred, a length of the troubleshooting session occurred over, a status of the troubleshooting session, and so forth.

FIG. 5B illustrates a GUI 520 of the support representative application to enter support representative profile information, according to an embodiment. The GUI 520 may be a website page, a page or sub-GUI of a computer or tablet device application, a page or sub-GUI of a smartphone application, a page or sub-GUI of a smart device application, and so forth. The GUI 520 may be part of the support representative application discussed above.

As discussed above, block 502 of the method in flowchart 500 may include generating a profile for a user. The GUI 520 may include a menu field 522 for a support representative and/or an administrator to select a page of the GUI 520 to input support representative profile information. The GUI 520 may also include a support representative profile section 524 with fields to receive support representative profile information. In one embodiment, the fields in the support representative profile section 524 may include text fields, image upload fields, graphical objects, buttons, drop-down menus, and so forth. In another embodiment, the fields may include a field to input a username, a password, a support representative identification number (SRID), a name, a phone number, an email address, address information, support department information, a business address, and so forth. In another example, the fields may input a field to input information about a supervisor of the support representative, such as a name of the supervisor, an email address of the supervisor, a phone number of the support representative, and so forth. In another example, the fields may include a save button.

FIG. 5C illustrates a GUI 530 of an initiated support representative application for a support representative awaiting an assistance request, according to an embodiment. The GUI 530 may be a website page, a page or sub-GUI of a computer or tablet device application, a page or sub-GUI of a smartphone application, a page or sub-GUI of a smart device application, and so forth. The GUI 530 may be part of the support representative application discussed above.

As discussed above, block 504 of the method in flowchart 500 of FIG. 5A may include initiating a support representative application at a support representative device. When the support representative application has been initiated, the support representative application may include the GUI 530 for a support representative to await an assistance request. The GUI 530 may include a tab button 532 for the support representative to open the GUI 530. The GUI: 530 may also include a section 534 to indicate whether the support representative application has received any assistance requests from smart devices associated with merchants.

FIG. 5D illustrates a GUI 540 of a support representative application displaying a malfunctioning device 546, according to an embodiment. The GUI 540 may be a website page, a page or sub-GUI of a computer or tablet device application, a page or sub-GUI of a smartphone application, a page or sub-GUI of a smart device application, and so forth. The GUI 540 may be part of the support representative application discussed above.

As discussed above, block 508 of the method in flowchart 500 of FIG. 5A may include displaying a GUI 540 on the support representative device showing a malfunctioning device 546. The GUI 540 may be initiated when the support representative accepts an assistance request. The GUI 540 may include a notes section 542 for the support representative to input notes using an input device regarding a troubleshooting session for the accepted assistance request.

The GUI 540 may also include a malfunctioning device section 544 to display an image or a video of the malfunctioning device 546. In one example, the image or the video may be previously captured image or video. In another example, the image or the video may be a live streaming image or video. The malfunctioning device section 544 may include a menu 548 for the support representative to generate text and/or a graphical object to overlay or integrate into the image or the video of the malfunctioning device 546. The menu 548 may include buttons for a support representative to select a typing function, a drawing function, or a visual cue function of the support representative application to help guide or assist a merchant through the troubleshooting process. In one example, the support representative may generate text 550 that is overlaid or integrated into the image or the video, where the text 550 may provide be an instruction message or prompt to aid a merchant in troubleshooting or fixing the malfunctioning device 546. In another example, the support representative may generate a graphical object 552 and/or 554 that is overlaid or integrated into the image or the video, where the graphical object 552 and/or 554 may a graphical object or prompt (such as a circle, a square, or other shape or object) to aid a merchant in troubleshooting or fixing the malfunctioning device 546.

In one embodiment, the support representative application may execute image recognition function or video recognition function to recognize features of the malfunctioning device 546, such as buttons, card slots, cords, screens, and so forth of the malfunctioning device 546. In one embodiment, when the image recognition function or video recognition function recognizing a feature of the malfunctioning device 546, the support representative application may automatically align the text 550, the graphical object 552 and/or 554, and/or media objects with the feature. In another embodiment, the support representative application may adjust the menu 548 to provide different options to the support representative to select to aid the support representative in assisting the merchant in troubleshooting or fixing the malfunctioning device 546. For example, the options may include graphical objects instructing the merchant to press a button, swipe a card, insert a card, plug or unplug the malfunctioning device 546, rotate the malfunctioning device 546, type in numbers or letters, and so forth.

As discussed above, block 512 of the method shown in flowchart 500 in FIG. 5A may include sending the additional information to a troubleshooting application executing on a smart device associated with the merchant. The additional information may be the text 550, the graphical object 552, and/or the graphical object 554. The GUI 540 may also include a merchant profile area 556 to display a merchant profile associated with the merchant or merchant device that send the assistance request.

FIG. 5E illustrates a GUI 560 of a support representative application displaying notification or message, according to an embodiment. The GUI 560 may be a website page, a page or sub-GUI of a computer or tablet device application, a page or sub-GUI of a smartphone application, a page or sub-GUI of a smart device application, and so forth. The GUI 560 may be part of the support representative application discussed above.

As discussed above, block 508 of the method in flowchart 500 of FIG. 5A may include displaying the GUI 540 in FIG. 5D on the support representative device showing a malfunctioning device 546. The GUI 540 may be initiated when the support representative accepts an assistance request. The GUI 560 may be overlaid on top of or integrated into the GUI 540. In one embodiment, the GM 560 may include a notification or message field 562 or box to receive information from the support representative via an input device. In one example, the notification or message field 562 may include a status indicator field 564 for the support representative to use an input device to select whether the troubleshooting session has been resolved or is still pending. In another example, the notification or message field 562 may include a text box 566 for the support representative to use the input device to input text into the text box 566 to record notes or information related to the troubleshooting session.

In another embodiment, the GUI 560 may include a notification or message field 562 to provide additional information to the support representative. For example, the notification or message field 562 may display a manual or troubleshooting guide to aid the support representative in finding information about the malfunctioning device 546 in FIG. 5D and/or an issue or problem associated with the malfunctioning device 546.

FIG. 5F illustrates a GUI 570 of a support representative application displaying support tickets 574A-E, according to an embodiment. The GUI 570 may be a website page, a page or sub-GUI of a computer or tablet device application, a page or sub-GUI of a smartphone application, a page or sub-GUI of a smart device application, and so forth. The GUI 570 may be part of the support representative application discussed above.

As discussed above, block 514 of the method in flowchart 500 of FIG. 5A may include generating a support ticket associated with a support representative troubleshooting a malfunctioning device. The GUI 570 may include a tab button 572 for the support representative to open the GUI 570. The GUI 570 may also include a support ticket section to display support tickets, such as support tickets 574A-E. The support tickets 574A-E may provide information about a troubleshooting session associated with the support representative and/or the merchant. The information of the support tickets 574A-E may include a name of the merchant, a name of a business associated by with the merchant, an ID number, a category of the troubleshooting session, an amount of time taken for the troubleshooting session, a date the troubleshooting session took place, how long ago the troubleshooting session took place, a status indicator of the troubleshooting session, actions to take associated with the troubleshooting session (such as editing, deleting, and/or viewing a support ticket 574A-E.

The above description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

It is to be understood that the above description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. A system, comprising:
a first device, wherein the first device is a malfunctioning device;
a holder, comprising:
a base that is a first planar structure, wherein the base comprises a top surface for the first device to be positioned on top of;
an arm extending upward from the base, wherein the arm is configured to support a platform; and
the platform that is a second planar structure, wherein the platform comprises a top surface for a second device to be positioned on top of;
the second device configured to execute a troubleshooting application to assist a first individual with troubleshooting or fixing the first device, wherein the second device comprises:
a camera located on a bottom surface of the second device, the camera being configured to capture an image or a video of the first device when the second device is located on the platform;
a first display located on a top surface of the second device, the first display being configured to display the image or the video; and
a first processing device coupled to the camera and the first display, the first processing device configured to send the image or the video of the first device to a third device; and
the third device configured to execute a support representative application to assist a second individual with assisting the first individual with troubleshooting or fixing the first device, wherein the third device comprises:
a second display; and
a second processing device coupled to the second display, wherein the second processing device is configured to:
receive the image or the video from the second device;
display a graphical user interface (GUI) on the second display;
receive troubleshooting information via the GUI; and
send the troubleshooting information to the second device, wherein the first processing device is configured to:
receive the troubleshooting information from the second processing device; and
display the troubleshooting information on the first display.

2. The system of claim 1, wherein the first device is a credit card processing device.

3. The system of claim 1, wherein:
the base extends along a latitudinal axis; and
the platform extends along a longitudinal axis such that the base is offset from the platform.

4. The system of claim 3, wherein the base is offset from the platform to position the camera over the first device to capture the image or the video.

5. The system of claim 1, wherein the first processing device is configured to:
generate a profile for the first individual;
initiate the troubleshooting application;
execute an assistance instruction;
initiate a connection between the second device and the third device;
initiate the camera; and
display the image or the video on the first display.

6. The system of claim 1, wherein the first processing device is configured to receive rating information for the second individual.

7. The system of claim 1, wherein the first processing device is configured to display support ticket information on the first display.

8. The system of claim 1, wherein the second processing device is configured to:
generate a support representative account;
initiate the support representative application;
initiate a connection between the first device and the second device; and
display the first device in the GUI. 9. The system of claim 1, wherein the second processing device is configured to generate a support ticket associated with the second individual.

10. The system of claim 1, wherein the troubleshooting information is overlaid onto the image or the video or integrated into the image or the video.

11. The system of claim 1, wherein the troubleshooting information is a text object providing an instruction or aid for the first individual to fix or troubleshoot the first device.

12. The system of claim 1, wherein the troubleshooting information is a graphical object providing an instruction or aid for the first individual to fix or troubleshoot the first device.

13. A system, comprising:
a first device configured to execute a troubleshooting application to assist a first individual with troubleshooting or fixing a malfunctioning device, wherein the first device comprises:
a camera configured to capture an image or a video of the malfunctioning device;
a first display located configured to display the image or the video; and
a first processing device coupled to the camera and the first display, the first processing device configured to send the image or the video of the malfunctioning device to a second device; and
a second device configured to execute a support representative application to assist a second individual with assisting the first individual with troubleshooting or fixing the malfunctioning device, wherein the second device comprises:
a second display; and
a second processing device coupled to the second display, wherein the second processing device is configured to:
receive the image or the video from the first device;
display a graphical user interface (GUI) on the second display;
receive troubleshooting information via the GUI; and
send the troubleshooting information to the first device, wherein the first processing device is configured to:
receive the troubleshooting information from the second processing device; and
display the troubleshooting information on the first display.

14. The system of claim 13, further comprising the malfunctioning device.

15. The system of claim 13, further comprising a holder, the holder comprising:
a base that is a first planar structure, wherein the base comprises a top surface for the malfunctioning device to be positioned on top of;
an arm extending upward from the base, wherein the arm is configured to support a platform; and
the platform that is a second planar structure, wherein the platform comprises a top surface for the first device to be positioned on top of.

16. The system of claim 13, wherein:
the troubleshooting information is overlaid onto the image or the video or integrated into the image or the video; and
the troubleshooting information is a text object or a graphical object providing an instruction or aid for the first individual to fix or troubleshoot the first device.

17. A method comprising:
executing, by a first processing device, a troubleshooting application to assist a first individual with troubleshooting or fixing a malfunctioning device;
capturing, by a camera, an image or a video of the malfunctioning device;
displaying, by a first display device, the image or the video;
sending, by the first processing device, the image or the video of the malfunctioning device to a second processing device;
executing, by the second processing device, a support representative application to assist a second individual with assisting the first individual with troubleshooting or fixing the malfunctioning device;
receiving, by the second processing device, the image or the video from the first processing device;
displaying, by a second display device, a graphical user interface (GUI);
receiving, by the GUI, troubleshooting information;
sending, by the second processing device, the troubleshooting information to the first processing device;
receiving, by the first processing device, the troubleshooting information from the second processing device; and
displaying, by the first display device, the troubleshooting information.

18. The method of claim 17, further comprising:
overlaying the troubleshooting information onto the image or the video; or
integrating the troubleshooting information into the image or the video.

19. The method of claim 17, wherein the troubleshooting information is a text object or a graphical object providing an instruction or aid for the first individual to fix or troubleshoot the first processing device.

20. The method of claim 17, wherein the malfunctioning device is a credit card processing device.
